(19) United States
(12) Patent Application Publication
(10) Pub. No.: US 2014/0065457 A1
(43) Pub. Date: Mar. 6, 2014

(54) MULTIPLE ELECTRODE SUBSTRATE THICKNESSES IN BATTERY CELLS FOR PORTABLE ELECTRONIC DEVICES

(71) Applicants: Ramesh C. Bhardwaj, Fremont, CA (US); Sheba Devan, Santa Clara, CA (US)

(72) Inventors: Ramesh C. Bhardwaj, Fremont, CA (US); Sheba Devan, Santa Clara, CA (US)

(73) Assignee: APPLE INC., Cupertino, CA (US)

(21) Appl. No.: 13/597,149

(22) Filed: Aug. 28, 2012

(51) Int. Cl. H01M 10/04; H01M 4/04; H01M 4/66; H01M 10/02; H01M 4/02; H01M 4/78

(52) U.S. Cl. 429/94; 429/209; 429/245; 429/156; 29/623.5

(57) ABSTRACT

The disclosed embodiments provide a battery cell. The battery cell includes an electrode containing an active material and a continuous substrate. The continuous substrate includes a first thickness to maintain a tensile strength of the continuous substrate and a second thickness that is less than the first thickness to accommodate the active material. The first and second thicknesses may thus improve the energy density and/or rate capability of the battery cell without producing manufacturing defects associated with the use of thinner electrode substrates in battery cells.

### BACKGROUND

1. Field

The disclosed embodiments relate to batteries for portable electronic devices. More specifically, the disclosed embodiments relate to techniques for creating multiple thicknesses in electrode substrates of batteries for portable electronic devices.

2. Related Art

Rechargeable batteries are presently used to provide power to a wide variety of portable electronic devices, including laptop computers, tablet computers, mobile phones, personal digital assistants (PDAs), digital music players and cordless power tools. The most commonly used type of rechargeable battery is a lithium battery, which can include a lithium-ion or a lithium-polymer battery.

Lithium-polymer batteries often include cells that are packaged in flexible pouches. Such pouches are typically lightweight and inexpensive to manufacture. Moreover, these pouches may be tailored to various cell dimensions, allowing lithium-polymer batteries to be used in space-constrained portable electronic devices such as mobile phones, laptop computers, and/or digital cameras. For example, a lithium-polymer battery cell may achieve a packaging efficiency of 90-95% by enclosing rolled electrodes and electrolyte in an aluminized laminated pouch. Multiple pouches may then be placed side-by-side within a portable electronic device and electrically coupled in series and/or in parallel to form a battery for the portable electronic device.

Furthermore, a reduction in one or more battery dimensions may enable the creation of portable electronic devices with small, thin, portable, and/or aesthetically pleasing form factors. For example, an increase in the energy density of a battery may facilitate a decrease in the battery's thickness while maintaining the battery's capacity. In turn, the decreased thickness may allow for a corresponding decrease in the thickness of the portable electronic device powered by the battery and/or the freeing up of space within the portable electronic device to accommodate other components (e.g., display, processor, memory, etc.).

Consequently, the use of portable electronic devices may be facilitated by improvements related to the packaging efficiency, capacity, form factor, design, and/or manufacturing of battery packs containing lithium-polymer battery cells.

### SUMMARY

The disclosed embodiments provide a battery cell. The battery cell includes an electrode containing an active material and a continuous substrate. The continuous substrate includes a first thickness to maintain a tensile strength of the continuous substrate and a second thickness that is less than the first thickness to accommodate the active material. The first and second thicknesses may thus improve the energy density and/or rate capability of the battery cell without producing manufacturing defects associated with the use of thinner electrode substrates in battery cells.

In some embodiments, the electrode is at least one of a cathode and an anode.

In some embodiments, the battery cell also includes a separator. During manufacture of the battery cell, the cathode, the anode, and the separator may be wound to create a jelly roll. Alternatively, the layers may be used to form other types of battery cell structures, such as bi-cell structures.

In some embodiments, the first and second thicknesses are created on one side or both sides of the continuous substrate.

In some embodiments, the first and second thicknesses are associated with at least one of a rectangular shape, a square shape, a triangular shape, a honeycomb shape, and a three-dimensional (3D) shape.

In some embodiments, the first and second thicknesses are created using at least one of an etching technique, a blasting technique, and a preferential-stretching technique.

### BRIEF DESCRIPTION OF THE FIGURES

FIG. 1 shows the placement of a battery in a computer system in accordance with the disclosed embodiments.

FIG. 2 shows a top-down view of a battery cell in accordance with the disclosed embodiments.

FIG. 3 shows an electrode for a battery cell in accordance with the disclosed embodiments.

FIG. 4 shows a cross-sectional view of a continuous substrate for an electrode of a battery cell in accordance with the disclosed embodiments.

FIG. 5 shows a top-down view of a continuous substrate for an electrode of a battery cell in accordance with the disclosed embodiments.

FIG. 6 shows a cross-sectional view of a continuous substrate for an electrode of a battery cell in accordance with the disclosed embodiments.

FIG. 7 shows a flowchart illustrating the process of manufacturing a battery cell in accordance with the disclosed embodiments.

FIG. 8 shows a portable electronic device in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

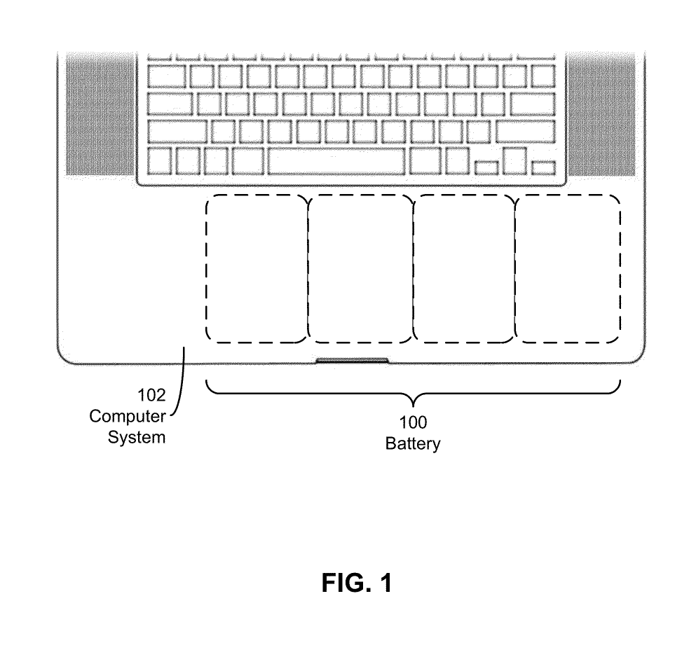

FIG. 1 shows the placement of a battery 100 in a computer system 102 in accordance with an embodiment. Computer system 102 may correspond to a laptop computer, personal digital assistant (PDA), portable media player, mobile phone, digital camera, tablet computer, and/or other portable electronic device. Battery 100 may correspond to a lithium-polymer battery and/or other type of rechargeable power source for computer system 102. For example, battery 100 may include one or more lithium-polymer battery cells packaged in flexible pouches. The battery cells may then be connected in series and/or in parallel and used to power computer system 102.

In one or more embodiments, battery 100 is designed to accommodate the space constraints of computer system 102. For example, battery 100 may include battery cells of different sizes and thicknesses that are placed side-by-side, top-to-bottom, and/or stacked within computer system 102 to fill up the free space within computer system 102. The use of space within computer system 102 may additionally be optimized by omitting a separate enclosure for battery 100. For example, battery 100 may include non-removable pouches of lithium-polymer cells encased directly within the enclosure for computer system 102. As a result, the cells of battery 100 may be larger than the cells of a comparable removable battery, which in turn may provide increased battery capacity and weight savings over the removable battery.

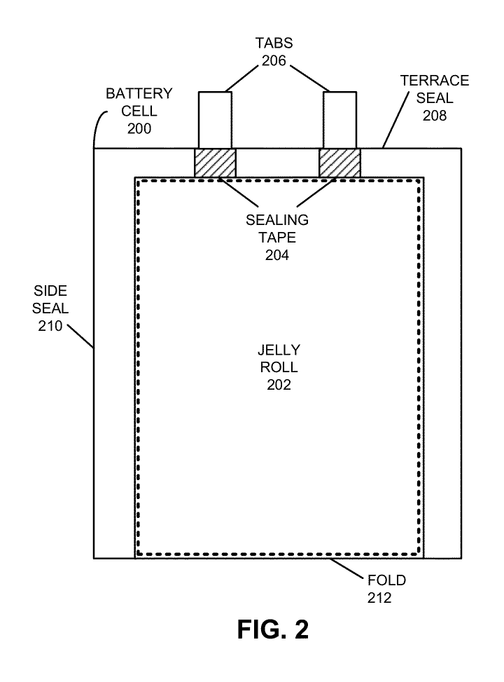

To further facilitate use of computer system 102 with battery 100, battery 100 may include a continuous electrode substrate with two or more thicknesses. For example, the electrode substrate may include a first thickness to maintain a tensile strength of the substrate and a second thickness to accommodate active material for the electrode. In turn, battery 100 may have a higher energy density and/or better rate capability than those of conventional lithium-polymer batteries. Improving the energy density and/or rate capability of lithium-polymer batteries is discussed in further detail below with respect to FIGS. 2-7.

FIG. 2 shows a battery cell 200 in accordance with an embodiment. Battery cell 200 may correspond to a lithium-polymer cell that is used to power a portable electronic device. Battery cell 200 includes a jelly roll 202 containing a number of layers which are wound together, including a cathode with an active coating, a separator, and an anode with an active coating.

More specifically, jelly roll 202 may include one strip of cathode material (e.g., aluminum foil coated with a lithium compound) and one strip of anode material (e.g., copper foil coated with carbon) separated by one strip of separator material (e.g., conducting polymer electrolyte). The cathode, anode, and separator layers may then be wound on a mandrel to form a spirally wound structure. Alternatively, the layers may be used to form other types of battery cell structures, such as bi-cell structures. Jelly rolls are well known in the art and will not be described further.

During assembly of battery cell 200, jelly roll 202 is enclosed in a flexible pouch, which is formed by folding a flexible sheet along a fold line 212. For example, the flexible sheet may be made of aluminum with a polymer film, such as polypropylene and/or polyethylene. After the flexible sheet is folded, the flexible sheet can be sealed, for example, by applying heat along a side seal 210 and along a terrace seal 208.

Jelly roll 202 also includes a set of conductive tabs 206 coupled to the cathode and the anode. Conductive tabs 206 may extend through seals in the pouch (for example, formed using sealing tape 204) to provide terminals for battery cell 200. Conductive tabs 206 may then be used to electrically couple battery cell 200 with one or more other battery cells to form a battery pack. For example, the battery pack may be formed by coupling the battery cells in a series, parallel, or series-and-parallel configuration.

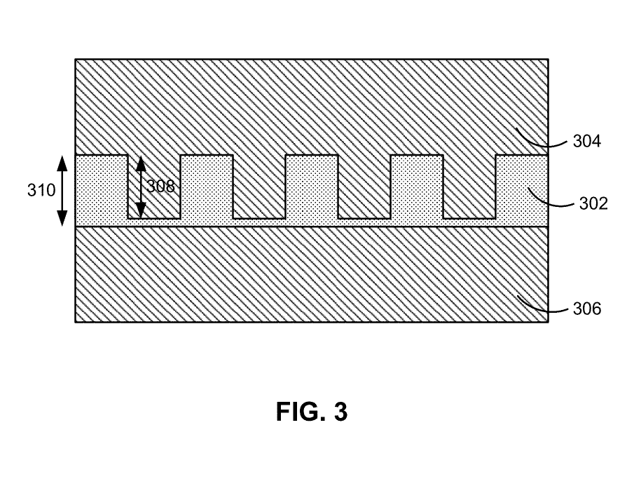

FIG. 3 shows an electrode for a battery cell in accordance with the disclosed embodiments. The electrode may provide a cathode and/or anode for the battery cell, such as battery cell 200 of FIG. 2. The electrode may include a continuous substrate 302 coated with active material 304-306. For example, continuous substrate 302 may be copper foil or aluminum foil coated on both sides with a carbon or lithium active material 304-306.

As shown in FIG. 3, continuous substrate 302 includes a first thickness 310 and a second thickness that is formed by removing a portion 308 of material from one side of first thickness 310. For example, an 8-micron portion 308 may be periodically removed from a 10-micron first thickness 310 in a sheet of aluminum and/or copper foil to form the second thickness in the foil.

First thickness 310 may maintain a tensile strength of continuous substrate 302 to mitigate manufacturing defects such as breaks, crinkles, convolutions, nicks, and/or dents during creation of the electrode and/or battery cell. On the other hand, the removed portion 308 may accommodate additional active material 304 in the battery cell, thus increasing the energy density of the battery cell over that of a conventional battery cell with a flat electrode substrate. For example, portion 308 may increase the thickness of active material 304 from 53 microns to 61 microns, thus providing a corresponding increase in the energy density of the battery cell. The removed portion 308 may also increase the surface area of continuous substrate 302, resulting in a corresponding increase in the rate capability and/or capacity rate (c-rate) of the battery cell over that of the conventional battery cell if both battery cells contain the same amount of active material 304-306.

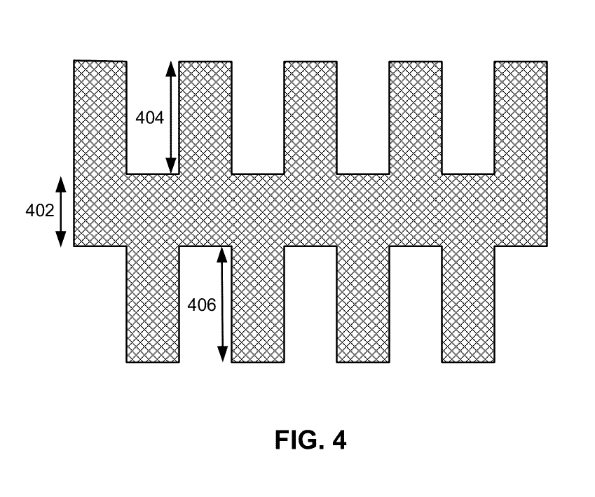

Portion 308 may be removed in a way that forms various shapes in continuous substrate 302. For example, the periodic removal of portion 308 may create rectangular, square, triangular, honeycomb, and/or three-dimensional (3D) shapes in continuous substrate 302. Shapes associated with multiple thicknesses in continuous substrates for battery cells are discussed in further detail below with respect to FIGS. 4-6.

Moreover, portion 308 may be removed from first thickness 310 using a variety of techniques. For example, the second thickness may be formed by removing portion 308 using an etching (e.g., photo etching, chemical etching, laser etching) technique. Alternatively, a blasting (e.g., sand blasting, bead blasting) technique may be used to selectively remove portion 308 from various parts of continuous substrate 302. Finally, the first and second thicknesses may be formed in continuous substrate 302 using a preferential-stretching technique, in which portion 308 is removed from continuous substrate 302 to form a set of shapes and/or patterns and continuous substrate 302 is stretched in one or more dimensions to increase the width of the shapes and/or patterns.

FIG. 4 shows a cross-sectional view of a continuous substrate for an electrode of a battery cell in accordance with the disclosed embodiments. As mentioned above, the continuous substrate may be used in a cathode and/or an anode of a battery cell (e.g., battery cell 200 of FIG. 2).

In addition, multiple thicknesses may be created in the continuous substrate by removing portions 404-406 of the continuous substrate from both sides (e.g., top and bottom) of the continuous substrate. For example, portions 404-406 that are 6 microns deep and 20-2000 microns wide may be removed from the continuous substrate in an alternating pattern so that a center thickness 402 of 4 microns is maintained throughout the continuous substrate and an additional thickness of the continuous substrate above or below thickness 402 is the same (e.g., 6 microns) at any point in the continuous substrate. Such removal of portions 404-406 may accommodate active material disposed over the top and bottom of the continuous substrate and/or increase the surface area of the continuous substrate, thus increasing the energy density of the battery cell and/or facilitating faster discharge of the battery cell.

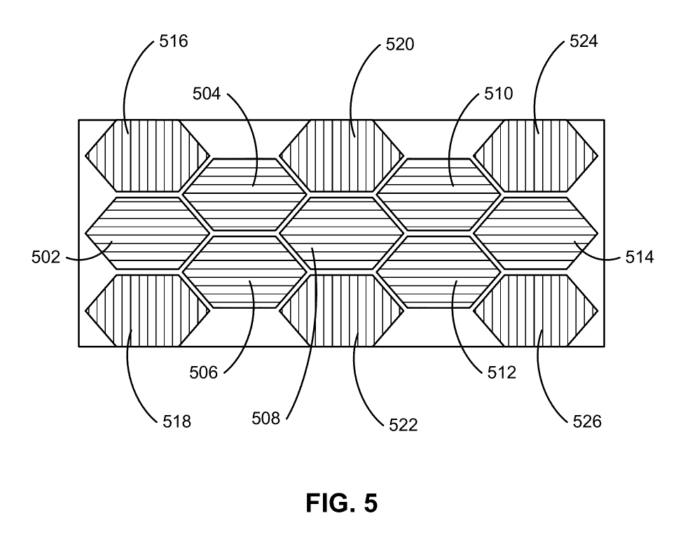

FIG. 5 shows a top-down view of a continuous substrate for an electrode of a battery cell in accordance with the disclosed embodiments. The continuous substrate includes a set of portions 502-526 removed from the surface of the continuous substrate in a honeycomb pattern and/or shape. In addition, portions 502-514 may be removed from one side (e.g., the top) of the continuous substrate, while portions 516-526 may be removed from the other side (e.g., the bottom) of the continuous substrate. Such removal of portions 502-526 from both sides of the continuous substrate may mitigate decreases in tensile strength caused by thinning of the continuous substrate while increasing the surface area of the continuous substrate and/or allowing for the addition of active material to the removed portions 502-526.

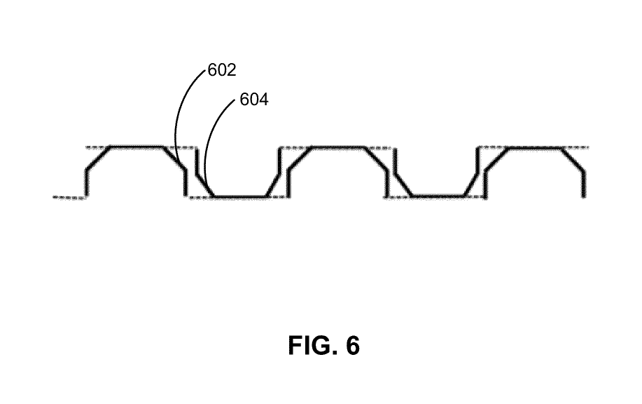

FIG. 6 shows a cross-sectional view of a continuous substrate for an electrode of a battery cell in accordance with the disclosed embodiments. More specifically, FIG. 6 shows a cross-sectional view of two sets of 3D shapes 602-604 that may be formed in the continuous substrate. For example, shapes 602-604 may be formed during the removal of one or more hexagonal portions 602-626 from the continuous substrate of FIG. 6.

Shape 602 may taper at an angle from the top of a first thickness of the continuous substrate, and then drop vertically until a boundary of a second thickness in the continuous substrate is reached. On the other hand, shape 604 may drop vertically from the top of the first thickness, and then taper at an angle until the boundary of the second thickness is reached. Shapes 602-604 may also be included in the same continuous substrate. For example, shape 602 may be created along the top of the continuous substrate, while shape 604 may be created along the bottom of the continuous substrate. The varying thicknesses of shapes 602-604 may maintain a tensile strength that averts manufacturing defects in the electrode and/or battery cell while enabling improvements in the energy density and/or rate capability of the battery cell.

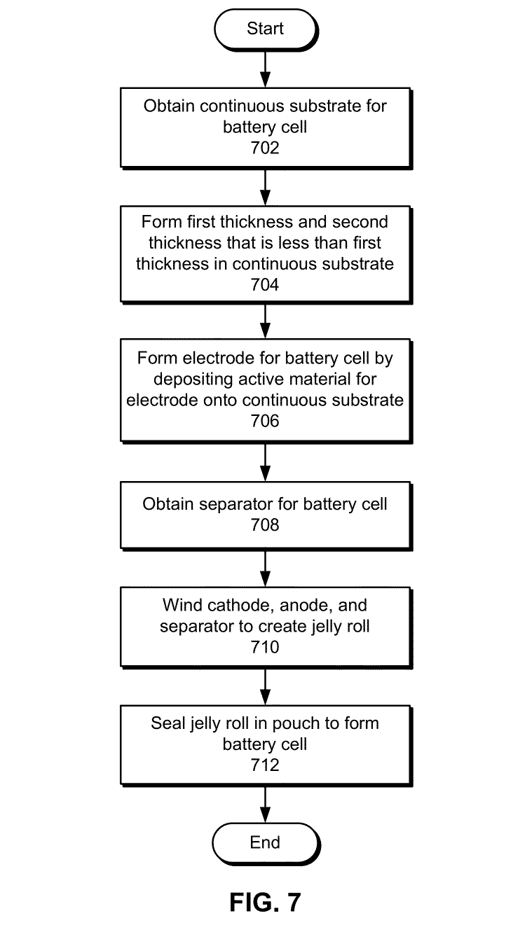

FIG. 7 shows a flowchart illustrating the process of manufacturing a battery cell in accordance with the disclosed embodiments. In one or more embodiments, one or more of the steps may be omitted, repeated, and/or performed in a different order. Accordingly, the specific arrangement of steps shown in FIG. 7 should not be construed as limiting the scope of the embodiments.

Initially, a continuous substrate for the battery cell is obtained (operation 702). The continuous substrate may be copper foil or aluminum foil for a lithium-polymer battery cell. Next, a first thickness and a second thickness that is less than the first thickness are formed in the continuous substrate (operation 704). The first and second thicknesses may be formed on one or both sides of the continuous substrate using an etching technique, a blasting technique, and/or a preferential-stretching technique. In addition, the first and second thicknesses may be associated with a rectangular, square, triangular, honeycomb, and/or 3D shape.

An electrode for the battery cell is then formed by depositing active material for the electrode onto the continuous substrate (operation 706). For example, cathode and/or anode active material may be coated, deposited, and/or sputtered onto the continuous substrate to form a cathode and/or anode for the battery cell. The first thickness may maintain the tensile strength of the continuous substrate, while the second thickness may accommodate the active material. Consequently, the first and second thicknesses may improve the energy density and/or rate capability of the battery cell without producing manufacturing defects associated with the use of thinner electrode substrates in battery cells.

A separator for the battery cell is also obtained (operation 708), and the cathode, anode, and separator are wound to create a jelly roll (operation 710). The winding step may be skipped and/or altered if the layers are used to create other battery cell structures, such as bi-cells. Finally, the jelly roll is sealed in a pouch to form the battery cell (operation 712). For example, the battery cell may be formed by placing the cathode, anode, and separator layers into the pouch, filling the pouch with electrolyte, and forming side and terrace seals along the edges of the pouch.

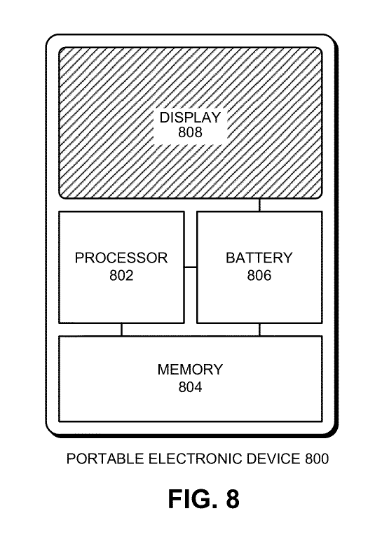

The above-described rechargeable battery cell can generally be used in any type of electronic device. For example, FIG. 8 illustrates a portable electronic device 800 which includes a processor 802, a memory 804 and a display 808, which are all powered by a battery 806. Portable electronic device 800 may correspond to a laptop computer, mobile phone, PDA, portable media player, digital camera, and/or other type of battery-powered electronic device. Battery 806 may correspond to a battery pack that includes one or more battery cells. Each battery cell may include an electrode with an active material and a continuous substrate. The continuous substrate may include a first thickness to maintain a tensile strength of the continuous substrate and a second thickness to accommodate the active material. The first and second thicknesses may increase the energy density and/or rate capability of the battery cell over that of a conventional battery cell with flat electrode substrates.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A battery cell, comprising:
an electrode, comprising:
an active material; and
a continuous substrate, comprising:
a first thickness to maintain a tensile strength of the continuous substrate; and
a second thickness that is less than the first thickness to accommodate the active material.

2. The battery cell of claim 1, wherein the electrode is at least one of a cathode and an anode.

3. The battery cell of claim 2, further comprising:
a separator,
wherein the cathode, the anode, and the separator are wound to create a jelly roll.

4. The battery cell of claim 1, wherein the continuous substrate comprises at least one of copper foil and aluminum foil.

5. The battery cell of claim 1, wherein the first and second thicknesses are created on one side or both sides of the continuous substrate.

6. The battery cell of claim 1, wherein the first and second thicknesses are associated with at least one of:
a rectangular shape;
a square shape;
a triangular shape;
a honeycomb shape; and
a three-dimensional (3D) shape.

7. The battery cell of claim 1, wherein the first and second thicknesses are created using at least one of:
an etching technique;
a blasting technique; and
a preferential-stretching technique.

8. A portable electronic device, comprising:
a set of components powered by a battery pack; and
the battery pack, comprising:
a battery cell, comprising:
an electrode, comprising:
an active material; and
a continuous substrate, comprising:
a first thickness to maintain a tensile strength of the continuous substrate; and
a second thickness that is less than the first thickness to accommodate the active material.

9. The portable electronic device of claim 8, wherein the electrode is at least one of a cathode and an anode.

10. The portable electronic device of claim 9, wherein the battery cell further comprises:
a separator,
wherein the cathode, the anode, and the separator are wound to create a jelly roll.

11. The portable electronic device of claim 8, wherein the continuous substrate comprises at least one of copper foil and aluminum foil.

12. The portable electronic device of claim 8, wherein the first and second thicknesses are created on one side or both sides of the continuous substrate.

13. The portable electronic device of claim 8, wherein the first and second thicknesses are associated with at least one of:
a rectangular shape;
a square shape;
a triangular shape;
a honeycomb shape; and
a three-dimensional (3D) shape.

14. The portable electronic device of claim 8, wherein the first and second thicknesses are created using at least one of:
an etching technique;
a blasting technique; and
a preferential-stretching technique.

15. A method for manufacturing a battery cell, comprising:
obtaining a continuous substrate for the battery cell;
forming a first thickness and a second thickness that is less than the first thickness in the continuous substrate; and
forming an electrode for the battery cell by depositing active material for the electrode onto the continuous substrate.

16. The method of claim 15, wherein the electrode is at least one of a cathode and an anode.

17. The method of claim 16, further comprising:
obtaining a separator for the battery cell; and
winding the cathode, the anode, and the separator to create a jelly roll.

18. The method of claim 17, further comprising:
sealing the jelly roll in a pouch to form the battery cell, wherein the pouch is flexible.

19. The method of claim 15, wherein the continuous substrate comprises at least one of copper foil and aluminum foil.

20. The method of claim 15, wherein the first and second thicknesses are created on one side or both sides of the continuous substrate.

21. The method of claim 15, wherein the first and second thicknesses are associated with at least one of:
a rectangular shape;
a square shape;
a triangular shape;
a honeycomb shape; and
a three-dimensional (3D) shape.

22. The method of claim 15, wherein the first and second thicknesses are created using at least one of:
an etching technique;
a blasting technique; and
a preferential-stretching technique.
